(19) United States
(12) Patent Application Publication
(10) Pub. No.: US 2003/0005431 A1
(43) Pub. Date: Jan. 2, 2003

(54) PVR-based system and method for TV content control using voice recognition

(75) Inventor: Hiroaki Shinohara, San Diego, CA (US)

Correspondence Address: John L. Rogitz, Rogitz & Associates, Suite 3120, 750 B Street, San Diego, CA, 92101, US

(73) Assignee: SONY CORPORATION, Tokyo (JP)

(21) Appl. No.: 09/898,432

(22) Filed: Jul. 2, 2001

(51) Int. Cl. H04N 7/16; H04H 9/00

(52) U.S. Cl. 725/12; 725/20; 725/28

(57) ABSTRACT

A system and method for controlling the content displayed on a TV based on recognizing a viewer's voice. A microprocessor in a PVR that is associated with the TV can recognize a viewer's voice and allow only appropriate programming to be played on the TV. Thus, for example, violent or sexually explicit programs or commercials can be screened from a viewer who is recognized as being a young person.

### BACKGROUND OF THE INVENTION

1. Field of the Invention

The present invention relates generally to television systems.

2. Description of the Related Art

Televisions and computers have become ubiquitous, and since both usually entail a visual display, efforts have been made to integrate both functions into a single system. In this way, a consumer need not purchase and operate two separate systems, which can burden some consumers who, while familiar with operating a television and its remote control, might not be familiar with operating, e.g., an Internet computer.

To the extent that attempts have been made to combine television with Internet features, it has generally been with the focus of producing what might be thought of as a “lean forward” system. That is, hybrid TV/computers have typically been more oriented toward productivity, generally thought of as a computer system characteristic, and less toward entertainment (“lean back”), generally regarded as a television system characteristic. It is not just the dichotomy between productivity and entertainment that distinguishes a “lean forward” experience from a “lean back” experience, however. As contemplated herein, “lean back” activities can extend to purchasing products that are advertised on TV, as opposed to, e.g., making products for sale. In any case, with the above-mentioned critical observation of the present invention in mind, it can readily be appreciated that the differences between a system designed for “lean forward” experiences and a system designed for “lean back” experiences can be both subtle and profound.

In the above context, the present invention recognizes that in one aspect of a lean-back experience, it might be desirable to permit any type of program to be played on a TV for some viewers, but to prevent certain types of programs, e.g., violent or sexually explicit programs, from being presented to other viewers, e.g., young children. The present invention further recognizes that such a screening feature based on viewer identity preferably be done automatically, i.e., without requiring a person to “lock” or “unlock” content using a keyboard or other “lean forward” type of device for each viewer. The solutions below have been provided with the above critical observations in mind.

### SUMMARY OF THE INVENTION

A system for screening televised content for display on a TV includes a TV and a personal video recorder (PVR) including a processor coupled to the TV. The processor receives televised content and accesses a biological characteristic recognition module, preferably a voice recognition module, to screen televised content.

In a preferred implementation, the processor can be part of a personal video recorder (PVR) such as but not limited to the present assignee's TiVO® device. Regardless of how implemented, the processor determines whether to allow presentation of televised content on the TV based on an output of the voice recognition module. In this regard, the processor may associate the output of the voice recognition module with a viewer profile stored in a database that is accessible to the processor. Moreover, the preferred processor may associate viewer preferences with a viewer profile using the output of the voice recognition module. The viewer preference can be a channel selection, commercial, or TV program. In any case, the profile with preferences can be sent to a marketing entity.

If desired, a database accessible to the processor and updatable with information available on the Internet can be included. Televised content can be stored in the database for playback on the TV based on the processor determining whether to allow presentation of the televised content on the TV based on the output of the voice recognition module.

In another aspect, a method for determining at least one content to display on a TV includes receiving the content, and receiving a viewer biological signal, preferably a vocal signal. Based on the vocal signal, it is determined whether to display the content.

In still another aspect, a TV system includes a TV, biologic recognition means, and processor means that access the recognition means for establishing what content is displayed on the TV.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is a block diagram of the system of the present invention; and

FIG. 2 is a flow chart of the present logic.

### DETAILED DESCRIPTION OF THE PREFERRED EMBODIMENTS

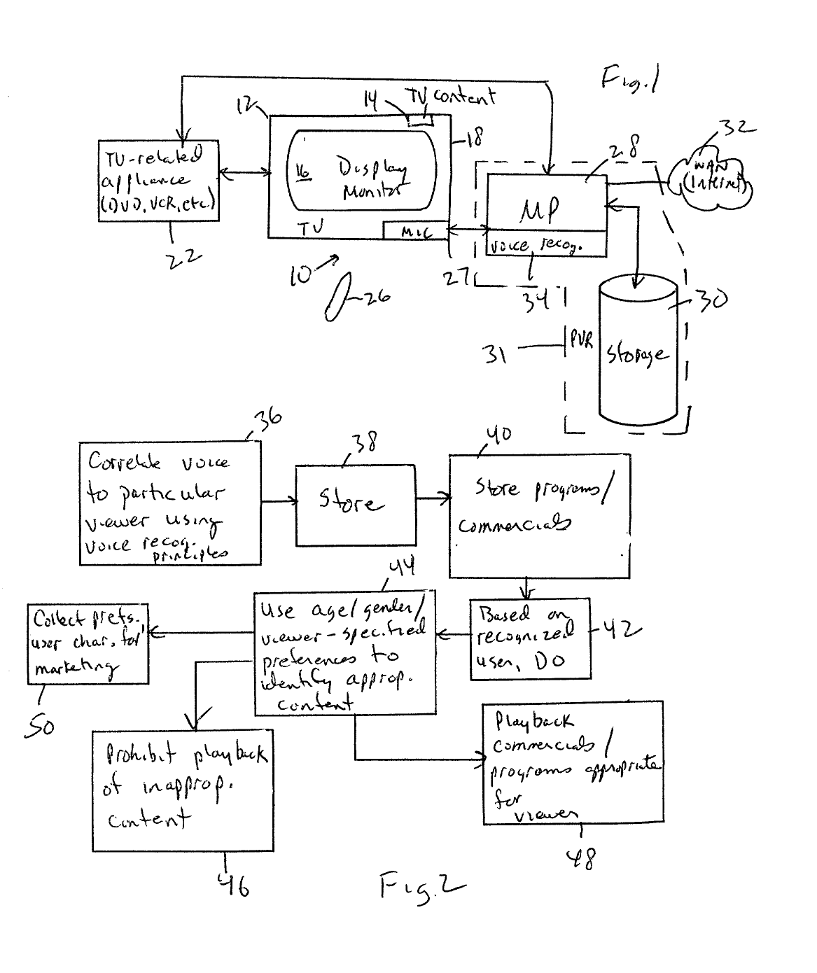

Referring initially to FIG. 1, a system is shown, generally designated 10. As shown, the system 10 includes a TV 12 that conventionally receives televised content at a content receiver 14 (e.g., an antenna, satellite dish, set-top box, etc.) for display of the content on a monitor 16.

While the embodiment below discusses a TV 12 with a single housing that is shown separate from the microprocessor and database, it is to be understood that the term “television” encompasses any apparatus that has a television tuner and the below-described capability in a single housing or in separate housings that cooperate together. For instance, the term “TV” encompasses the television system shown in FIG. 1, as well as a conventional television in combination with a set-top box or personal video recorder (PVR) that functions in accordance with the present invention. In the latter example, the set-top box or PVR might include, e.g., the microprocessor discussed below. In a less preferred embodiment, the microprocessor discussed below can be a standalone computer such as a PC or laptop with its own monitor (not shown), and can communicate with the TV 12 by wired or wireless link or simply by transferring data from the TV to the computer using, e.g., a floppy diskette.

In the preferred non-limiting embodiment shown, the TV 12 includes a housing 18 that holds a conventional television tuner which receives the TV signals. The audio and video settings of the TV, i.e., the volume, tone, tint, color, contrast, and so on as conventionally provided in the art, are established by respective adjustable audio and video setting circuits. Also, the TV 12 can display media-stored content on the monitor 16 received from a TV-related appliance 22 that is associated with the TV, such as but not limited to a DVD player that can play DVD disks in accordance with principles known in the art.

While FIG. 1 shows that the appliance 22 is separate from the TV housing 18, it is to be understood that the appliance 22 can be incorporated into the housing 18. Moreover, other types of players, such as compact disk (CD) players, flash memory readers, and so on can be used as the appliance 22, in which case the DVD disk would be replaced by, respectively, a CD, flash memory medium, etc. In any case, the media-stored content provided from the appliance, that is, the player that is associated with the TV, is distinct from broadcast content received from an antenna, satellite dish, or cable. When used without a modifier, however, “content” refers to both media-stored content and to broadcast content.

The TV 12 with appliance 22 can be operated by a viewer by appropriately manipulating a remote control user input device 26 or other controls located on the housing 18. It is to be understood that while FIG. 1 shows that the U/I device 26 can be a conventional TV remote control device, other devices can be used, such as but not limited to keyboards, keypads, mice, touch screen technology, voice activation/recognition technology, etc.

A microphone 27 is incorporated in the system 10, preferably on the TV housing 18 as shown. Moreover, a microprocessor 28 receives TV content and signals from the microphone 27, and the microprocessor 28 can store data in a database 30. As intimated above, the preferred microprocessor 28 and if desired database 30 is integrated with the TV 12 (in the housing 18 or in a separate but associated housing 31 such as a personal video recorder (PVR), e.g., Sony's “TiVO” device) in such a manner as to receive the content automatically. When incorporated into a PVR, the database 30 can be implemented into a hard disk drive (HDD) of the PVR.

If desired, the microprocessor 28 can also communicate with a wide area network, such as but not limited to the Internet 32, via cable or wire modem, DSL link, wireless link, or other network link in accordance with principles known in the art to access computer sites on, e.g., the World Wide Web. As intimated above, the microprocessor 28 (and/or the database 30) can be located in the housing 18 or it can be disposed elsewhere, such as in a set-top box, remote control U/I device 26, PVR, etc.

In any case, the microprocessor 28 accesses a software-implemented biometric module 34 to execute the logic set forth herein. The module 34 can be any appropriate voice recognition device or system known in the art, such as, without limitation, one or more of the systems disclosed in the present assignee's U.S. Pat. Nos. 4,592,085, 5,583,965, 5,764,853, and 5,956,684, incorporated herein by reference.

Or, the module 34 can rely on biosensors other than voice recognition. For instance, the module 34 can rely on face recognition technology or fingerprint recognition technology to establish the identity of the particular viewer. When face recognition technology is used, the microphone 27 could be replaced by a camera, whereas when fingerprint technology is used, the microphone 27 could be replaced by a fingerprint reader mounted on the TV 12 or on, e.g., the remote control U/I device 26. In any case, the database 30 can be contained in computer memory, or on a hard disk drive, optical drive, solid state storage, tape drive, removable flash memory, or any other suitable data storage medium.

It may now be appreciated that the microprocessor 28 undertakes the logic below. The flow charts herein illustrate the structure of the logic modules of the present invention as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer or microprocessor) to perform a sequence of function steps corresponding to those shown. Internal logic could be as simple as a state machine.

In other words, the present logic may be established as a computer program that is executed by a processor within, e.g., the present microprocessors/servers as a series of computer-executable instructions. In addition to residing on hard disk drives, these instructions may reside, for example, in RAM of the appropriate computer, or the instructions may be stored on magnetic tape, electronic read-only memory, or other appropriate data storage device.

Now referring to the logic diagram shown in FIG. 2, at block 36 a viewer's voice (or other biological characteristic such as face or fingerprint) is correlated or otherwise associated with a viewer identity. This can be done by inputting a viewer's name, e.g., “This is John”, using the input device 26 or by speaking the input data into the microphone 27. The input can be made in response to a prompt displayed on the monitor 16, if desired. Or, the voice recognition module can use spectral analysis, e.g., voice tone, pitch, frequency, modulation, etc. to classify a vocal signal as belonging to a new or existing viewer, and then create a viewer identity and automatically associate the voice with it.

Furthermore, a viewer profile can be associated with the viewer identity at block 36. The profile can include age, gender, and other characteristics, including programming likes and dislikes. In one aspect, programming likes and dislikes can be ascertained based on a historical viewing record such as is currently undertaken in Sony's TiVO device, it being understood that in the present invention, a PVR-based microprocessor 28 does not merely access a generic viewing history that represents the composite viewing habits of multiple people in a household, but rather one history in a set of histories, with each history in the set representing only the viewing habits of an individual viewer.

In another aspect, the viewer profile can be established by information input by a person using the input device 26 or recognition module 34. Alternatively, the viewer profile can be established by classifying the vocal signal as mentioned above and then comparing the classified vocal signal with predetermined profiles (e.g., “older man”, “young girl”, etc.) that can be stored in the database 30 and periodically updated with information that is downloaded from the Internet 32. If desired, at block 38 the viewer identity can be stored, along with the corresponding profile, in a viewer file in the database 30.

Proceeding to block 40, content, including television programs and commercials and possibly including recorded content that is played on the appliance 22, can be stored at block 40. If desired, only content that is classified as “appropriate” in accordance with the disclosure below can be stored in the database at block 40. Moving to block 42, when a vocal signal from a viewer is recognized either by the viewer speaking his or her name or automatically based on vocal classification, a DO loop is entered. Proceeding to block 44, the viewer's profile is accessed. Based on the profile, content recorded at block 40 is essentially categorized into “appropriate” or “inappropriate”. For example, for a viewer profile indicating “young child”, violent or sexually explicit content or other content defined as “inappropriate” for the particular viewer profile can be screened from view at block 46, whereas content classified as being “appropriate”, such as toy and cereal commercials and cartoon programs, can be made available for display on the TV 12 at block 48. The content made available for viewing can be content that is stored in the database 30 or that is received real-time at the TV 12.

To classify content as “appropriate” or “inappropriate” for a particular viewer, a person can simply input “appropriate” and “inappropriate” television channels and/or broadcast times and/or particular shows or content genre as part of the viewer's profile. Or, in the case of the above-mentioned predetermined profiles, content can be classified for each predetermined profile based on heuristic classifications that are history-based. In any case, it will be appreciated that once a viewer identity is ascertained by means of a vocal signal, that viewer's profile can be accessed to determine whether to display a particular content.

As contemplated herein, viewer preferences are associated with a viewer profile at block 50 by, e.g., adding the preferences to the viewer's file in the database 30. Viewer preferences include, without limitation, channel selections, commercials, or TV programs that are displayed on the TV 12 while the viewer is watching the TV, as indicated by the recognition module 34 and as sensed by the processor 28. That is, viewer preferences can be gathered by the processor 28 automatically and added to the particular history associated with that viewer. Or, a viewer might elect to manually or vocally input preferences in response to prompts displayed on the monitor 16. In any case, as indicated in FIG. 2 the viewer profile with preferences can be sent to a marketing entity by means of, e.g., the Internet 32 or other data transfer mechanism, for use of the information in designing TV content.

While the particular PVR-BASED SYSTEM AND METHOD FOR TV CONTENT CONTROL USING VOICE RECOGNITION as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “at least one”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for”.

I claim:

1. A system for screening televised content for display on a TV, comprising:
a TV; and
a personal video recorder (PVR) including a processor coupled to the TV and receiving televised content, the processor accessing a biological characteristic recognition module to screen televised content.

2. The system of claim 1, wherein the processor determines whether to allow presentation of televised content on the TV based on an output of the recognition module.

3. The system of claim 2, wherein the processor associates the output of the recognition module with at least one viewer profile stored in a database accessible to the processor.

4. The system of claim 3, wherein the processor associates at least some viewer preferences with at least one viewer profile using the output of the recognition module.

5. The system of claim 4, wherein at least one viewer preference is a channel selection.

6. The system of claim 5, wherein the televised content is at least one commercial or TV program.

7. The system of claim 1, comprising a database accessible to the processor and updatable with information available on a wide area network.

8. The system of claim 4, wherein the processor sends at least one viewer profile with preferences to at least one marketing entity.

9. The system of claim 1, wherein the recognition module is a voice recognition module.

10. A method for determining at least one content to display on a TV, comprising:
receiving the content;
receiving at least one viewer biological signal; and
based on the biological signal, determining whether to display the content.

11. The method of claim 10, comprising:
establishing at least one viewer file; and
associating the biological signal with the viewer file.

12. The method of claim 11, wherein a viewer profile is associated with the biological signal, and the biological signal is a vocal signal.

13. The method of claim 12, wherein the viewer profile is established at least in part by information input by a person.

14. The method of claim 12, wherein the viewer profile is established at least in part by classifying the vocal signal and comparing the classified vocal signal with at least one predetermined profile.

15. The method of claim 12, wherein the act of determining uses the viewer profile.

16. The method of claim 12, further comprising associating at least one viewer preference with the viewer profile.

17. The method of claim 16, wherein at least one viewer preference is a channel selection.

18. The method of claim 10, wherein the content is at least one commercial or TV program.

19. The method of claim 17, comprising sending at least one viewer profile with preferences to at least one marketing entity.

20. The method of claim 12, comprising storing the content for playback on the TV based on determining whether to allow presentation of the content based on the vocal signal.

21. A system, comprising:
a TV;
biological recognition means; and
processor means accessing the biological recognition means for establishing what content is displayed on the TV.

22. The system of claim 21, wherein the processor means includes means for associating a viewer profile with a voice, and the biological recognition means is a voice recognition means.

23. The system of claim 22, wherein the viewer profile is established at least in part by information input by a person.

24. The system of claim 22, wherein the viewer profile is established at least in part by classifying a vocal signal and comparing the classified vocal signal with at least one predetermined profile.

25. The system of claim 22, wherein the processor means includes means for associating at least one viewer preference with the viewer profile.

26. The system of claim 25, wherein at least one viewer preference is a channel selection.

27. The system of claim 21, wherein the content is at least one commercial or TV program.

28. The system of claim 21, further comprising means for sending at least one viewer profile with preferences to at least one marketing entity.

29. The system of claim 21, further comprising means for storing the content for playback on the TV based on determining whether to allow presentation of the content.

31. The system of claim 21, wherein the processor means is associated with a personal video recorder (PVR).
